(19) United States
(12) Patent Application Publication
(10) Pub. No.: US 2014/0187186 A1
(43) Pub. Date: Jul. 3, 2014

(54) Wake Up Circuit and A Method for Forming One

(71) Applicants: Pekka Pursula, Espoo (FI); Ville Viikari, Helsinki (FI)

(72) Inventors: Pekka Pursula, Espoo (FI); Ville Viikari, Helsinki (FI)

(73) Assignee: TEKNOLOGIAN TUTKIMUSKESKUS VTT, VTT (FI)

(21) Appl. No.: 14/123,965

(22) PCT Filed: Jun. 4, 2012
(86) PCT No.: PCT/FI2012/050548

§ 371 Date: Mar. 12, 2014

(30) Foreign Application Priority Data
Jun. 6, 2011 (FI) 20115546

(51) Int. Cl. H04B 1/16; H04W 52/02

(52) U.S. Cl. CPC H04B 1/1615; H04W 52/0229
USPC 455/227

(57) ABSTRACT

The invention relates to a wake up circuit comprising an antenna with a matching circuit, a wake up radio electrically coupled to the antenna, and an electronic circuit electrically connected to the antenna and the wake up radio such that the wake up radio triggers the electronic circuit on with a predetermined signal. In accordance with the invention between the antenna and the wake up radio is connected a passive mixer.

### FIELD OF THE INVENTION

The present invention relates to a wake up circuit according to the preamble of Claim 1.

The invention also relates to a method.

### BACKGROUND OF THE INVENTION

In the prior art a radio receiver of a sensor circuit or a sensor cell has to be switched on in order to be able wake up the sensor circuit. Based on a standard crystal can be designed a clock with accuracy of 20-50 ppm whereby the timing error, in other words the extra listening time is at worst 4 seconds per day. The power consumption of the sensor is dependent also on the desired response time (=delay from measurement command to the actual measurement). Short response time requires frequent on time for the receiver increasing the power consumption.

In the wireless sensor circuits most of the power consumption (about 10 mA) is formed in the radio receiver. The problem may be solved by a wake-up radio, the power consumption of which is around 1 μA. Wake up radios are available commercially only to unpractically low frequencies (100 kHz).

In the prior art the minimizing of the power consumption is in some embodiments performed by reducing the duty ratio of the radio circuit. In this case the radio is switched on as short times as possible. In reception this is a big problem, while reception of short transmission bursts requires a long enough switch on time for the receiver with high power consumption. The “listening time” in the reception is determined by the accuracy of the clock of the sensor circuit: the more accurate the clock is, the more precise the synchronization for the expected transmission is and consequently the shorter the switching on time of the receiver is. If more precision is required the power consumption rises correspondingly. A standard solution is a crystal oscillator with accuracy of about 20-50 ppm (as in wrist watches), but then the timing error is in the worst case 4s a day, the time the radio has to be switched on unnecessarily.

Wake up radios are a known solution, but the circuits are designed for low frequencies. In these frequencies the circuits are cheap and sensitive and the power consumption is low. 100 kHz carrier frequency does not suit for sensor circuits having an operational range even 100 meters. The wavelength of 100 kHz radio waves is about 330 kilometers and therefore the emitting antenna should be very long. At low frequencies e.g. in connection with access cards near-field coupling is used, which enables a very low operation range (˜0.1 m). There are prototypes also for wake-up circuits for higher frequencies, but the power consumption and sensitivity are worse than with low frequency circuits.

### SUMMARY OF THE INVENTION

The invention is intended to eliminate at least some of the shortcomings defects of the state of the art disclosed above and for this purpose create an entirely new type of a wake up radio and method.

The invention is based on using a passive mixer like a non-linear circuit connected to a wake up radio for generating from carrier frequency a low frequency signal required by the wake-up circuit.

More specifically, the apparatus to the invention is characterized by what is stated in the characterizing portion of Claim 1.

The method according to the invention is, in turn, characterized by what is stated in the characterizing portion of Claim 6.

Considerable advantages are gained with the aid of the invention.

The invention enables reducing the power consumption of high frequency sensor networks (e.g. Zigbee 2.45 GHz). The invention can be used by any frequency band. In the invention in addition to the wake-up circuit there is only a circuit consisting of simple passive components (e.g. diode and some coils and capacitors).

In connection with the invention passive mixing or diode detector is used to transfer the signal from carrier frequency to intermediate or base-band frequency (IF=the operation frequency of the wake-up circuit, 100 kHz). Saving need for a local oscillator, the approach reduces reception current consumption dramatically; the receiver can be on all the time, removing the latency and still achieving lower current consumption than the scheduled active radio. In addition to this, when both RF and LO uses the same reference signal, the correlated noise cancels and the base-band bandwidth can be extremely narrow, providing higher signal-to-noise ratio.

The unique features of the invention are e.g. the following:
superheterodyne receiver based on passive intermediate mixing,
passive mixing,
wake-up functionality with low power consumption with any carrier frequency, and
usage of wake up functionality in connection with analog or digital sensors (e.g. sensor ID).

In the following, the invention is examined with the aid of examples and with reference to the accompanying drawings.

### BRIEF DESCRIPTION OF THE DRAWINGS

FIG. 1 shows schematically a circuit in accordance with the invention.

### DETAILED DESCRIPT OF EMBODIMENTS

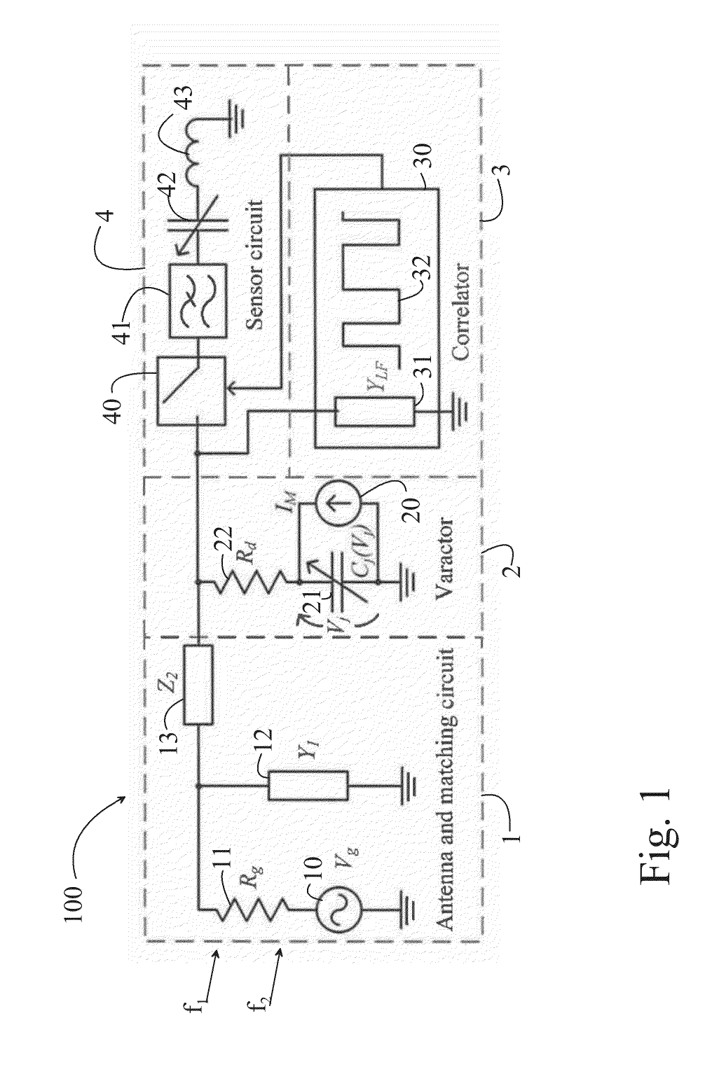

In accordance with FIG. 1 the signal Δf (=f₁−f₂) travels via antenna 1 to the non-linear element 2, which mixes the signal to an intermediate or base-band frequency (e.g. 100 kHz) of the wake up circuit 3. The mixing takes place non-actively, in other words mixing does not require a local oscillator. The sensitivity may be improved by DC-bias over the non-linear element 2, but this is not absolutely necessary. Because the signal is not mixed directly to the signal frequency (e.g. DC) but to the operational frequency (e.g. 100 kHz) of the wake up circuit 3. Mixing can be performed by any non-linear element, e.g. resistive diode like Schottky diode, capacitive varactor diode, e.g. hyperabrupt varactor diode, MEMS-structure or ferroelectric varactor.

With the invention may be in practice controlled any electronic device: a complete sensor cell, active radio circuit, any other digital circuit, sensor based on intermodulation or any other analog sensor. RFID-circuit with digital output at LF, HF or UHF-frequencies can also be used as a wake-up circuit.

Further, in accordance with figure 1 a sensor cell typically comprises the following basic elements: antenna and matching circuit 1, mixing element in form of a passive non-linear 2 element like varactor, diode, ferroelectric a MEMS device, a low frequency wake-up circuit 3 e.g. in form of a correlator and an electronic circuit 4 like a sensor circuit.

The problem with commercial wake up circuits is a very low carrier frequency, typically 100 kHz, which makes it practically impossible to use in small sensor circuits. The invention enables the use of a low frequency wake up circuit at any carrier frequency, e.g. at 2.45 GHz used by majority of sensor networks (e.g. Zigbee and Bluetooth—protocols). The wireless sensor networks are commercialized rapidly. Global markets are today in Billion euros and the growth of the market is more than 10%. With help of the invention power consumption of all sensor networks may be reduced and functionality improved.

In practice e.g. a commercially available wake up radio designed for low frequencies (e.g. AS3930¹: 100 kHz) can be used in connection with the invention. This kind of a radio listens continuously its' surroundings and switches on an active radio (or another desired circuit), when a predetermined bit sequence (sensor circuit ID) is detected. The power consumption of a wake up radio is in order of 1 μA, which enables a continuous power on mode and hence a short response time. ¹Austriamicrosystems, AS3930 Single Channel Low Frequency Wakeup Receiver, Datasheet.

The Operation Principle of the Wake-Up Module Based on Passive Frequency Mixing

Again, referring to figure 1, the transponder 100 receives two closely located frequencies f₁ and f₂ transmitted by the reader (not shown). The signals are matched by elements 12 and 13 to the mixing element 2, a Schottky diode 21, 22, 23 in FIG. 1, which produces a signal at the difference frequency Δf. The difference frequency Δf is then applied to a low-frequency (˜100 kHz) correlator 30 that compares the received code 32 to the correlator code (ID). When the codes match, the correlator 30 wakes up a radio transmitter or switches a sensor circuit 4 on for the predetermined time period. In case of a radio transmitter, sensor block 4 of figure 1 is replaced by the radio transmitter.

When the wake-up circuit 3 is used with a radio transmitter, the radio transmitter can be a separate system, or both wake-up circuit 3 and the transmitter may share the same antenna 1. When the wakeup circuit is used as an ID for a analog sensor, the sensor information is read-out by the intermodulation read-out principle. The sensor circuit 4 is connected to the mixing element with a switch 40.

### Sensitivity of the Wake-Up System

In the following analysis, we derive an expression for the sensitivity of the wake-up system. In the analysis we consider the matching circuit 12, 13 presented in FIG. 1, although other matching topologies can be used as well. In addition, we consider a varactor diode 20, 21, 22 as the mixing element 2.

The antenna is illuminated with two frequencies f₁ (angular frequency ω₁) and f₂ (angular frequency ω₂) and it produces a voltage of

$$\begin{matrix}{V}_{g} = 2 \sqrt{2 {P}_{in} {R}_{g}} ( sin {ω}_{i} t + sin {ω}_{2} t ) \\ = {\hat{V}}_{g} ( sin {ω}_{1} t + sin {ω}_{2} t ) ,\end{matrix} \qquad ( 1 )$$

where Pᵢₙ, is the received power at one frequency, R_{g} is the antenna resistance 11, and ω₁, and ω₂ are the angular frequencies of the sinusoids. Considering the circuit of FIG. 1, the voltage transfer function from the antenna (generator) 10 to the junction capacitance 21 is

$$\begin{matrix}{S}_{jg} = \frac{{V}_{j}}{{V}_{g}} \\ = \frac{{Y}_{d}}{jω {C}_{j 0} [ {Z}_{2} ( {Y}_{d} + {Y}_{LF} ) + 1 + {R}_{g} [ {Z}_{2} {Y}_{1} ( {Y}_{d} + {Y}_{LF} ) + {Y}_{1} + {Y}_{d} + {Y}_{LF} ] ]} ,\end{matrix} \qquad ( 2 )$$

where Y_{d}=1/(R_{d}+1/(jωCⱼ₀)) is the small-signal admittance of the diode, R_{d} is the series resistance 22 of the diode, and Cⱼ₀ is the junction capacitance 21 at a zero bias. Let us consider an unbiased Schottky varactor diode. The junction resistance at zero bias is typically very large (˜mega Ohms) and can be neglected. In addition, we assume no parasitic capacitance or series inductance for simplicity. The voltage-dependent junction capacitance 21 of the varactor is given as

$${C}_{j} ( {V}_{j} ) = \frac{{C}_{j 0}}{{( 1 - \frac{{V}_{j}}{Φ} )}^{γ}} , \qquad ( 3 )$$

where γ is the profile parameter for the depletion capacitance (γ=0.5 for uniformly doped junction) and Φ, is the junction potential. The charge stored in the capacitor is given as

$${Q}_{j} ( {V}_{j} ) = \int {C}_{j} ( {V}_{j} ) d {V}_{j} = \frac{Φ {C}_{j 0}}{1 - γ} {( 1 - \frac{{V}_{j}}{Φ} )}^{- γ + 1} , \qquad ( 4 )$$

where possible constant charge is omitted. The second order Taylor's approximation for the charge is

$${Q}_{j} ( {V}_{j} ) \approx {C}_{j 0} {V}_{j} + \frac{γ {C}_{j 0}}{2 Φ} {V}_{j}^{2} . \qquad ( 5 )$$

The current of the equivalent Norton current source 20 in parallel with the junction capacitance 21 (shown in FIG. 1) is given as

$${I}_{j} = \frac{d {Q}_{j} ( {V}_{j} )}{d t} \approx jω {C}_{j 0} {V}_{j} + jω \frac{γ {C}_{j 0}}{2 Φ} {V}_{j}^{2} . \qquad ( 6 )$$

The first term represents the currents of a normal (voltage-independent capacitance) capacitor whereas the second term generates mixing products. The modulated current of the equivalent current generator is obtained by substituting (1) and (2) into (6):

$${I}_{j , m} \approx jω \frac{γ {C}_{j 0} {\hat{V}}_{g}^{2}}{2 Φ} {( {S}_{jg} ( {ω}_{1} ) sin {ω}_{1} t + {S}_{jg} ( {ω}_{2} ) sin {ω}_{2} t )}^{2} . \qquad ( 7 )$$

The current at the difference frequency f_{Δ}=f₂−f₁ is

$${I}_{j} ( {ω}_{Δ} ) \approx {jω}_{Δ} \frac{γ {C}_{j 0} {\hat{V}}_{g}^{2} {S}_{jg} ( {ω}_{i} ) {S}_{jg} ( {ω}_{2} )}{2 Φ} cos {ω}_{Δ} t . \qquad ( 8 )$$

The voltage at the difference frequency across the junction is given as

$${V}_{j} ( {ω}_{Δ} ) = \frac{{jω}_{Δ} {C}_{j 0} γ {\hat{V}}_{g}^{2} {S}_{jg} ( {ω}_{1} ) {S}_{jg} ( {ω}_{2} ) {Z}_{N} ( {ω}_{Δ} )}{2 Φ} cos {ω}_{Δ t ,} \qquad ( 9 )$$

Assuming that the antenna 10, 11 and the matching circuit 12, 13 represent an infinite impedance at the difference frequency, the frequency difference is small compared to the RF-band, and that the RF-impedance of the correlator 30 is much greater than the impedance of the mixing diode, we can approximate (9) as

$${V}_{j} ( {ω}_{Δ} ) = \frac{{jω}_{Δ} γ {PQ}_{RF} {Z}_{LF} ( {ω}_{Δ} )}{2 {ω}_{RF} Φ} cos {ω}_{Δ} t , \qquad ( 11 )$$

The power sensitivity is

$$P = \frac{2 {ω}_{RF} Φ {V}_{TH}}{{ω}_{Δ Y} {Q}_{RF} {z}_{t , P} ( {ω}_{Δ} )} , \qquad ( 12 )$$

where VTH is the threshold voltage of the correlator 30. Assuming the RF-frequency of f_{RF}=2.5 GHz, the difference frequency of f_{Δ}=100 kHz, the junction potential Φ=1 V, the depletion coefficient of γ=1, the correlator 30 resistance 31 of Z_{LF}=1 MΩ, the threshold voltage of the correlator 30, V_{TH}=100 μV, and the RF-quality factor of Q_{RF}=10, the threshold power is P=5*10⁻⁷ W=−33 dBm.

Instead of sensor cell 100 the invention may be used in connection with any electronics, where optimization of power consumption is necessary.

In short the invention combines low power consumption to a commercial, low frequency (100 kHz) wake up circuit and enables the usage of it with any carrier frequency. To the input of the wake up circuit is matched a non-linear element at the operational frequency (e.g. 100 kHz), which non-linear element is also matched to an antenna at a desired carrier frequency (e.g. 2.45 GHz). A reader device sends at the carrier frequency a signal, which is distorted by the non-linear element. The distorted signal includes the low frequency (e.g. 100 kHz) signal required by wake up circuit. The distorted signal includes also the ID bit sequence required by the sensor.

### REFERENCES

²The IDTechEx report, “Active RFID and Sensor Networks 2011-2021,” Aug. 16, 2010, available at http://www.electroiq.com/index/display/packaging-article-display/2043907298/articles/advancedpackaging/packagingO/industry-news/201O/augustlidtechex-launches.html.

³Jukka Koskinen, “Herätysradio lyhyen kantaman radiosovelluksiin”, Diplomityö, Sähkö-ja tietoliikennetekniikan osasto, TKK, Helmikuu 2007.

1. A wake up circuit comprising:
an antenna with a matching circuit,
a wake up radio electrically coupled to the antenna, and
an electronic circuit electrically connected to the antenna and to the wake up radio such that the wake up radio triggers the electronic circuit on with a predetermined signal,
wherein between the antenna and the wake up radio is connected a passive mixer for generating a low frequency signal (IF) for the wake up radio.

2. An apparatus according to claim 1, wherein the passive mixer is a non-linear element functioning as a passive mixer.

3. An apparatus according to claim 1, wherein between the antenna and non-linear element is positioned a matching circuit.

4. An apparatus according to claim 1, wherein the non-linear element is a resistive diode, a capacitive varactor diode, a MEMS-structure or a ferroelectric varactor.

5. An apparatus according to claim 1, wherein the electronic circuit is an analog sensor circuit, a digital sensor circuit, a radio receiver, or a RFID circuit.

6. A method for a wake up circuit comprising the following method steps:
receiving a signal (f₁, f₂) with an antenna,
converting the received signal (f₁, f₂) to a lower frequency by a passive mixer before feeding to a wake up radio,
feeding the received signal (f₁, f₂) to a wake up radio,
waking up an electronic circuit connected to the antenna if the received signal meets predetermined conditions.

7. A method according to claim 6, further comprising using a non-linear element as a passive mixer.

8. A method according to claim 6, further comprising positioning the non-linear element between the antenna and a matching circuit.

9. A method according to claim 6, further comprising selecting the non-linear element from a resistive diode, a capacitive varactor diode, a MEMS-structure or a ferroelectric varactor.

10. A method according to claim 6, further comprising selecting the electronic circuit from an analog sensor circuit, a digital sensor circuit, a radio receiver or a RFID circuit.
